(19) United States
(12) Patent Application Publication
(10) Pub. No.: US 2023/0351469 A1
(43) Pub. Date: Nov. 2, 2023

(54) METHOD AND SYSTEM FOR FACILITATING ELECTRONIC TRANSACTIONS

(71) Applicant: JPMorgan Chase Bank, N.A., New York, NY (US)

(72) Inventors: Praveen YELUKATI, Monroe, NJ (US); Srinu DASARI, Euless, TX (US)

(73) Assignee: JPMorgan Chase Bank, N.A., New York, NY (US)

(21) Appl. No.: 17/661,407

(22) Filed: Apr. 29, 2022

(51) Int. Cl. G06Q 30/06; G06Q 20/40; G06Q 20/38; G06Q 30/02

(52) U.S. Cl. CPC G06Q 30/0631; G06Q 20/401; G06Q 20/389; G06Q 30/0283

(57) ABSTRACT

A method for providing personalized recommendations in real-time to facilitate electronic transactions is disclosed. The method includes automatically aggregating reference data from various sources, the reference data including user data and merchant data; receiving, via an application programming interface, an indication from a user, the indication including data that relates to a corresponding user activity; identifying a profile that corresponds to the user; determining, in real-time by using a model, recommendations for the user based on the indication, the reference data, and the profile; and providing, via the application programming interface, the recommendations to the user in response to the indication.

### BACKGROUND

### 1. Field of the Disclosure

This technology generally relates to methods and systems for facilitating electronic transactions, and more particularly to methods and systems for providing personalized recommendations in real-time via predictive analytics and data aggregation to facilitate electronic transactions.

### 2. Background Information

Many consumers rely on entities such as, for example, crowd sourced and expert managed deal sites to make financially prudent purchasing decisions. Often, the entities provide reward information, pricing information, and coupon information for various products and services relevant to the consumers. Historically, utilization of these conventional entities by the consumers has resulted in varying degrees of success with respect to maximizing on value and/or return for expended resources.

One drawback of using these conventional entities is that in many instances, the entities are information aggregators that merely provide available options to the consumers. As a result, the consumers must expend large quantities of resources in order to leverage the available options holistically. Additionally, due to the generalized nature of the information from the entities, the consumers are often inundated with information that may or may not be relevant.

Therefore, there is a need to automatically provide personalized recommendations to consumers in real-time via predictive analytics and data aggregation to facilitate efficient and financially prudent transactions.

### SUMMARY

The present disclosure, through one or more of its various aspects, embodiments, and/or specific features or sub-components, provides, inter alia, various systems, servers, devices, methods, media, programs, and platforms for providing personalized recommendations in real-time via predictive analytics and data aggregation to facilitate electronic transactions.

According to an aspect of the present disclosure, a method for providing personalized recommendations in real-time to facilitate electronic transactions is disclosed. The method is implemented by at least one processor. The method may include automatically aggregating reference data from at least one source, the reference data may include user data and merchant data; receiving, via an application programming interface, an indication from at least one user, the indication may include data that relates to a corresponding user activity; identifying at least one profile that corresponds to the at least one user; determining, in real-time by using at least one model, at least one recommendation for the at least one user based on the indication, the reference data, and the at least one profile; and providing, via the application programming interface, the at least one recommendation to the at least one user in response to the indication.

In accordance with an exemplary embodiment, the user data may include information that corresponds to the at least one user, the information may relate to at least one from among banking account information, payment card information, membership information, and rewards information.

In accordance with an exemplary embodiment, the merchant data may include information that corresponds to at least one merchant, the information may relate to at least one from among promotion information, calendar information, pricing information, availability information, geographic location information, product information, and service information.

In accordance with an exemplary embodiment, the user activity may relate to an interaction between the at least one user and at least one electronic transaction platform via a graphical user interface, the interaction may include a purchasing interaction.

In accordance with an exemplary embodiment, the purchasing interaction may relate to a procurement of at least one from among a consumer product, a real property, an automobile, a financial instrument, and an insurance product.

In accordance with an exemplary embodiment, the method may further include retrieving, via a graphical user interface, at least one preference that corresponds to the at least one user; parsing the reference data to identify the user data that corresponds to the at least one user; and enriching the at least one profile that corresponds to the at least one user with the at least one preference and the identified user data.

In accordance with an exemplary embodiment, the method may further include generating, by using the at least one model, a transaction journey data set for each of the at least one user based on the enriched at least one profile, the transaction journey data set may relate to a pattern of consumption; and associating the transaction journey data set with the corresponding at least one user.

In accordance with an exemplary embodiment, the at least one recommendation may include an action, a predicted outcome based on the action, and a predicted purchasing characteristic that relates to the user activity, the predicted purchasing characteristic may include a net cost characteristic.

In accordance with an exemplary embodiment, the at least one model may include at least one from among a machine learning model, a mathematical model, a process model, and a data model.

According to an aspect of the present disclosure, a computing device configured to implement an execution of a method for providing personalized recommendations in real-time to facilitate electronic transactions is disclosed. The computing device including a processor; a memory; and a communication interface coupled to each of the processor and the memory, wherein the processor may be configured to automatically aggregate reference data from at least one source, the reference data may include user data and merchant data; receive, via an application programming interface, an indication from at least one user, the indication may include data that relates to a corresponding user activity; identify at least one profile that corresponds to the at least one user; determine, in real-time by using at least one model, at least one recommendation for the at least one user based on the indication, the reference data, and the at least one profile; and provide, via the application programming interface, the at least one recommendation to the at least one user in response to the indication.

In accordance with an exemplary embodiment, the user data may include information that corresponds to the at least one user, the information may relate to at least one from among banking account information, payment card information, membership information, and rewards information.

In accordance with an exemplary embodiment, the merchant data may include information that corresponds to at least one merchant, the information may relate to at least one from among promotion information, calendar information, pricing information, availability information, geographic location information, product information, and service information.

In accordance with an exemplary embodiment, the user activity may relate to an interaction between the at least one user and at least one electronic transaction platform via a graphical user interface, the interaction may include a purchasing interaction.

In accordance with an exemplary embodiment, the purchasing interaction may relate to a procurement of at least one from among a consumer product, a real property, an automobile, a financial instrument, and an insurance product.

In accordance with an exemplary embodiment, the processor may be further configured to retrieve, via a graphical user interface, at least one preference that corresponds to the at least one user; parse the reference data to identify the user data that corresponds to the at least one user; and enrich the at least one profile that corresponds to the at least one user with the at least one preference and the identified user data.

In accordance with an exemplary embodiment, the processor may be further configured to generate, by using the at least one model, a transaction journey data set for each of the at least one user based on the enriched at least one profile, the transaction journey data set may relate to a pattern of consumption; and associate the transaction journey data set with the corresponding at least one user.

In accordance with an exemplary embodiment, the at least one recommendation may include an action, a predicted outcome based on the action, and a predicted purchasing characteristic that relates to the user activity, the predicted purchasing characteristic may include a net cost characteristic.

In accordance with an exemplary embodiment, the at least one model may include at least one from among a machine learning model, a mathematical model, a process model, and a data model.

According to an aspect of the present disclosure, a non-transitory computer readable storage medium storing instructions for providing personalized recommendations in real-time to facilitate electronic transactions is disclosed. The storage medium including executable code which, when executed by a processor, may cause the processor to automatically aggregate reference data from at least one source, the reference data may include user data and merchant data; receive, via an application programming interface, an indication from at least one user, the indication may include data that relates to a corresponding user activity; identify at least one profile that corresponds to the at least one user; determine, in real-time by using at least one model, at least one recommendation for the at least one user based on the indication, the reference data, and the at least one profile; and provide, via the application programming interface, the at least one recommendation to the at least one user in response to the indication.

In accordance with an exemplary embodiment, the at least one recommendation may include an action, a predicted outcome based on the action, and a predicted purchasing characteristic that relates to the user activity, the predicted purchasing characteristic may include a net cost characteristic.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing personalized recommendations in real-time via predictive analytics and data aggregation to facilitate electronic transactions.

FIG. 4 is a flowchart of an exemplary process for implementing a method for providing personalized recommendations in real-time via predictive analytics and data aggregation to facilitate electronic transactions.

FIG. 5 is a flow diagram of an exemplary process for implementing a method for providing personalized recommendations in real-time via predictive analytics and data aggregation to facilitate electronic transactions.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

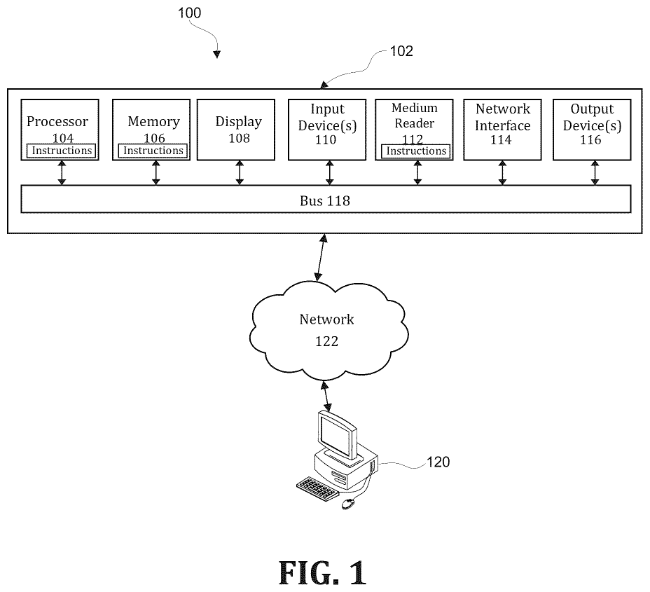

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing personalized recommendations in real-time via predictive analytics and data aggregation to facilitate electronic transactions.

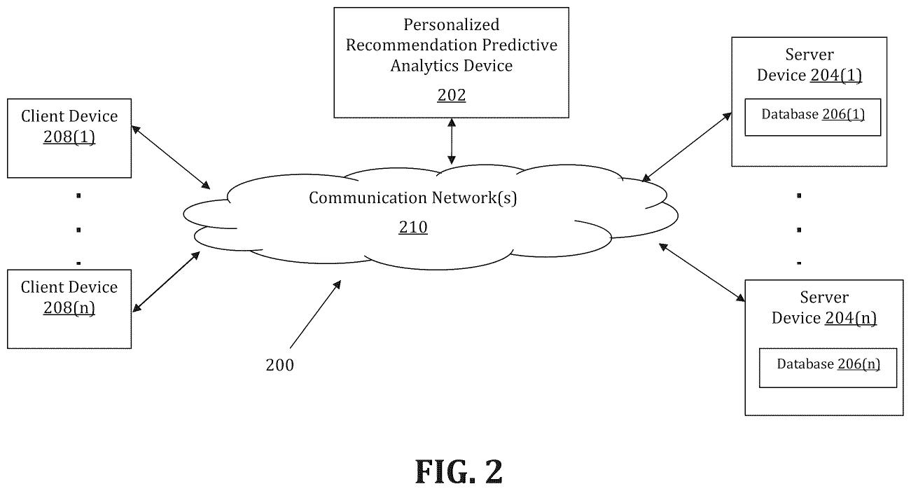

Referring to FIG. 2, a schematic of an exemplary network environment 200 for implementing a method for providing personalized recommendations in real-time via predictive analytics and data aggregation to facilitate electronic transactions is illustrated. In an exemplary embodiment, the method is executable on any networked computer platform, such as, for example, a personal computer (PC).

The method for providing personalized recommendations in real-time via predictive analytics and data aggregation to facilitate electronic transactions may be implemented by a Personalized Recommendation Predictive Analytics (PRPA) device 202. The PRPA device 202 may be the same or similar to the computer system 102 as described with respect to FIG. 1. The PRPA device 202 may store one or more applications that can include executable instructions that, when executed by the PRPA device 202, cause the PRPA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the PRPA device 202 itself, may be located in virtual server(s) running in a cloud-based computing environment rather than being tied to one or more specific physical network computing devices. Also, the application(s) may be running in one or more virtual machines (VMs) executing on the PRPA device 202. Additionally, in one or more embodiments of this technology, virtual machine(s) running on the PRPA device 202 may be managed or supervised by a hypervisor.

In the network environment 200 of FIG. 2, the PRPA device 202 is coupled to a plurality of server devices 204(1)-204(n) that hosts a plurality of databases 206(1)-206(n), and also to a plurality of client devices 208(1)-208(n) via communication network(s) 210. A communication interface of the PRPA device 202, such as the network interface 114 of the computer system 102 of FIG. 1, operatively couples and communicates between the PRPA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the PRPA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and PRPA devices that efficiently implement a method for providing personalized recommendations in real-time via predictive analytics and data aggregation to facilitate electronic transactions.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The PRPA device 202 may be a standalone device or integrated with one or more other devices or apparatuses, such as one or more of the server devices 204(1)-204(n), for example. In one particular example, the PRPA device 202 may include or be hosted by one of the server devices 204(1)-204(n), and other arrangements are also possible. Moreover, one or more of the devices of the PRPA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the PRPA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to reference data, user data, merchant data, vendor data, indications, user activities, profiles, and data models.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the PRPA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the PRPA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the PRPA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the PRPA device 202, the server devices 204(1)-204(n), or the client devices 208(1)-208(n), for example, may be configured to operate as virtual instances on the same physical machine. In other words, one or more of the PRPA device 202, the server devices 204(1)-204(n), or the client devices 208(1)-208(n) may operate on the same physical device rather than as separate devices communicating through communication network(s) 210. Additionally, there may be more or fewer PRPA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

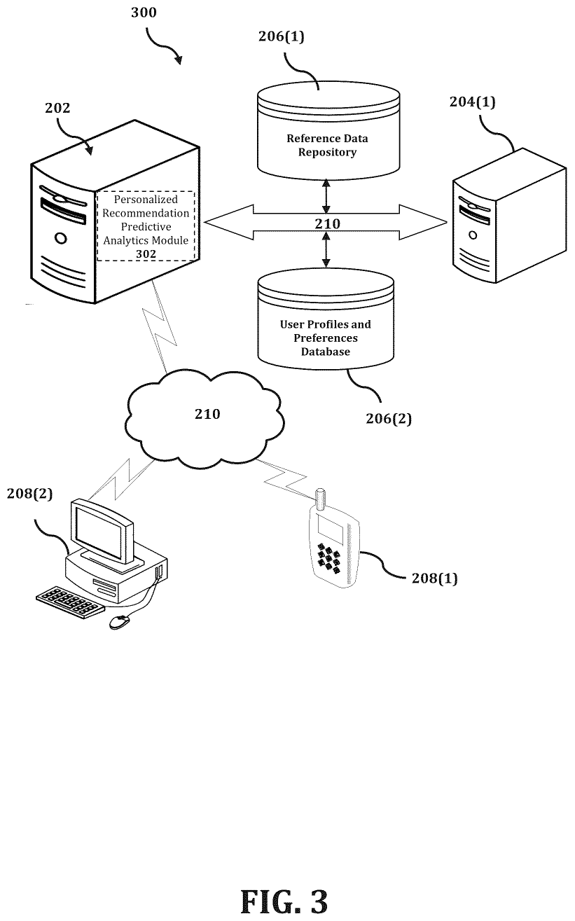

The PRPA device 202 is described and shown in FIG. 3 as including a personalized recommendation predictive analytics module 302, although it may include other rules, policies, modules, databases, or applications, for example. As will be described below, the personalized recommendation predictive analytics module 302 is configured to implement a method for providing personalized recommendations in real-time via predictive analytics and data aggregation to facilitate electronic transactions.

An exemplary process 300 for implementing a mechanism for providing personalized recommendations in real-time via predictive analytics and data aggregation to facilitate electronic transactions by utilizing the network environment of FIG. 2 is shown as being executed in FIG. 3. Specifically, a first client device 208(1) and a second client device 208(2) are illustrated as being in communication with PRPA device 202. In this regard, the first client device 208(1) and the second client device 208(2) may be “clients” of the PRPA device 202 and are described herein as such. Nevertheless, it is to be known and understood that the first client device 208(1) and/or the second client device 208(2) need not necessarily be “clients” of the PRPA device 202, or any entity described in association therewith herein. Any additional or alternative relationship may exist between either or both of the first client device 208(1) and the second client device 208(2) and the PRPA device 202, or no relationship may exist.

Further, PRPA device 202 is illustrated as being able to access a reference data repository 206(1) and a user profiles and preferences database 206(2). The personalized recommendation predictive analytics module 302 may be configured to access these databases for implementing a method for providing personalized recommendations in real-time via predictive analytics and data aggregation to facilitate electronic transactions.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the PRPA device 202 via broadband or cellular communication. Of course, these embodiments are merely exemplary and are not limiting or exhaustive.

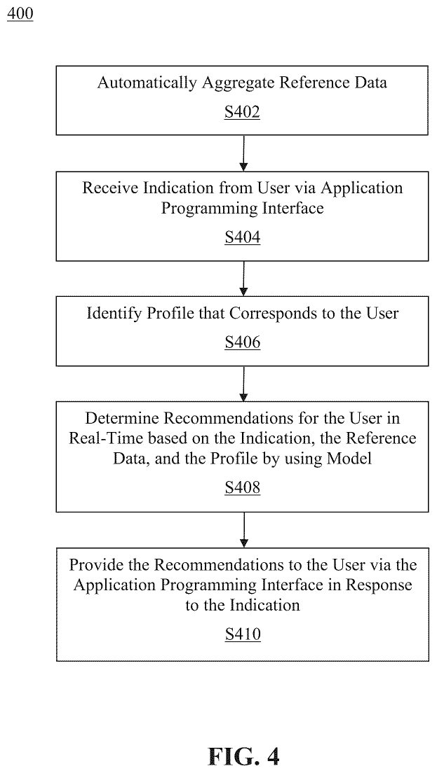

Upon being started, the personalized recommendation predictive analytics module 302 executes a process for providing personalized recommendations in real-time via predictive analytics and data aggregation to facilitate electronic transactions. An exemplary process for providing personalized recommendations in real-time via predictive analytics and data aggregation to facilitate electronic transactions is generally indicated at flowchart 400 in FIG. 4.

In the process 400 of FIG. 4, at step S402, reference data may be automatically aggregated from various sources. The reference data may include user data and merchant data. In an exemplary embodiment, the reference data may relate to quantities, characters, and/or symbols upon which operations are performed by a computer. The reference data may be stored and transmitted in the form of electrical signals and recorded on magnetic, optical, and/or mechanical recording media consistent with present disclosures. In another exemplary embodiment, the reference data may include data in any file format and data structure. The file format may specify how information in the reference data is encoded for storage by a computing device.

In another exemplary embodiment, the reference data may include product and service data that are crowd sourced and/or expert managed. The product and service data may include reward and coupon information from manufacturers, retailers, first-party data sources, and/or third-party data vendors. In another exemplary embodiment, the product data may include information that relates to tangible commodities that may be delivered to a customer to facilitate a transfer of ownership and possession from a seller to a buyer. For example, the product data for a car may include pricing information, model information, as well as specifications such as a power rating and a range rating. In another exemplary embodiment, the service data may include information that relates to intangible activities which are performed, separately identifiable, and provides satisfaction of wants. For example, the service data for an accounting service may include pricing information for particular tasks such as annual tax filings.

In another exemplary embodiment, the user data may include information that corresponds to a user consistent with present disclosures. The information may relate to at least one from among banking account information, payment card information, membership information, and rewards information. For example, the user data may include information such as store card reward information, online membership information, credit card reward information, credit card cash back information, credit card reward scale information, as well as bank cash and/or credit balances.

In another exemplary embodiment, the merchant data may include information that correspond to a plurality of merchants consistent with present disclosures. The information may relate to at least one from among promotion information, calendar information, pricing information, availability information, geographic location information, product information, and service information. For example, the merchant data may include information such as seasonal sale day calendar information, retail store pricing information, stock keeping unit (SKU) information, store promotion information, cross honoring stores information, as well as retail and online prices information.

In another exemplary embodiment, the reference data may be automatically aggregated from a source based on a predetermined schedule. For example, the reference data may be automatically aggregated once a week from source A. In another exemplary embodiment, initiation of the aggregation process may be initiated ad hoc based on a preference. For example, the aggregation process may be initiated by an administrator outside of scheduled aggregation in response to a new product release. In another exemplary embodiment, the source may correspond to a first-party data source as well as a third-party data source. The first-party data source may include internal data management systems such as, for example, a client account management system and the third-party data source may include external data providers such as, for example, external data vendors.

In another exemplary embodiment, the reference data may be aggregated from the source in an unstructured data format. For example, the reference data may be aggregated from the source in an incompatible data format. When the reference data is received from the source in the unstructured data format, the claimed invention may automatically generate a structured data set based on the unstructured data to facilitate processing of the reference data. For example, a structured data set with information in a compatible format may be automatically generated based on an automated mapping of the unstructured data to facilitate parsing actions. In another exemplary embodiment, the reference data may be aggregated from the source in a structured data format. For example, the reference data may be aggregated from the source in a compatible data format.

At step S404, an indication may be received from a user via an application programming interface (API). The indication may include data that relates to a corresponding user activity. In an exemplary embodiment, the user activity may relate to an interaction between the user and an electronic transaction platform. The interaction between the user and an electronic transaction platform may include a purchasing interaction that is facilitated by a graphical user interface. In another exemplary embodiment, the purchasing interaction may relate to a procurement of a product and/or a service. The procurement action may relate to the procurement of at least one from among a consumer product, a real property, an automobile, a financial instrument, and an insurance product.

In another exemplary embodiment, the indication may correspond to an action and/or an occurrence such as, for example, an event that is recognized by computing software. The event may be generated and/or triggered by an interface system as well as by the user. For example, the user may interact with the software via computing peripherals such as by typing on a keyboard and/or interacting with a graphical user interface. Likewise, the software may trigger a set of events into an event loop to communicate the completion of a task.

In another exemplary embodiment, utilization of the API to receive the indication may afford flexibility in implementing the claimed invention. By using the API, the claimed invention may be embedded into an existing platform thereby making it easier to integrate the claimed invention within a current product ecosystem. The API may facilitate the integration of the claimed invention within existing applications, websites, and/or portals. In another exemplary embodiment, the claimed invention may be delivered as a standalone application to ensure integration into a specific experience journey that is separate from retailers and/or financial portfolios.

In another exemplary embodiment, the application may include at least one from among a monolithic application and a microservice application. The monolithic application may describe a single-tiered software application where the user interface and data access code are combined into a single program from a single platform. The monolithic application may be self-contained and independent from other computing applications.

In another exemplary embodiment, the microservice application may include a unique service and a unique process that communicates with other services and processes over a network to fulfill a goal. The microservice application may be independently deployable and organized around business capabilities. In another exemplary embodiment, the microservices may relate to a software development architecture such as, for example, an event-driven architecture made up of event producers and event consumers in a loosely coupled choreography. The event producer may detect or sense an event such as, for example, a significant occurrence or change in state for system hardware or software and represent the event as a message. The event message may then be transmitted to the event consumer via event channels for processing.

In another exemplary embodiment, the event-driven architecture may include a distributed data streaming platform such as, for example, an APACHE KAFKA platform for the publishing, subscribing, storing, and processing of event streams in real time. As will be appreciated by a person of ordinary skill in the art, each microservice in a microservice choreography may perform corresponding actions independently and may not require any external instructions.

In another exemplary embodiment, microservices may relate to a software development architecture such as, for example, a service-oriented architecture which arranges a complex application as a collection of coupled modular services. The modular services may include small, independently versioned, and scalable customer-focused services with specific business goals. The services may communicate with other services over standard protocols with well-defined interfaces. In another exemplary embodiment, the microservices may utilize technology-agnostic communication protocols such as, for example, a Hypertext Transfer Protocol (HTTP) to communicate over a network and may be implemented by using different programming languages, databases, hardware environments, and software environments.

At step S406, a profile that corresponds to the user may be identified. In an exemplary embodiment, the profile may relate to a record of the user's psychological and/or behavioral characteristics and preferences. The profile may include predetermined preferences that relate to a desired shopping experience of the user. For example, the profile may include a predetermined preference of the user to identify the lowest net cost for a particular product based on available promotions and coupons. The profile may also include user characteristics such as, for example, financial user characteristics and personal user characteristics. For example, the financial user characteristics may relate to current account information and current investment portfolios whereas personal user characteristics may relate to a user's age, marital status, and occupation.

In another exemplary embodiment, the profile that corresponds to the user may be automatically identified based on aggregated user data. The user's psychological and/or behavioral characteristics and preferences may be automatically determined based on historical transaction data and account data of the user. In another exemplary embodiment, machine learning and artificial intelligence techniques consistent with present disclosures may be used to automatically determine the profile of the user from the historical transaction data and the account data. For example, patterns in user spending may be used to infer user preferences and tendencies.

At step S408, recommendations may be determined for the user based on the indication, the reference data, and the corresponding profile. The recommendations may be determined for the user in real-time by using a model.

In an exemplary embodiment, the recommendations may be determined by using models such as, for example, decision models. The recommendations may include an action, a predicted outcome based on the action, and a predicted purchasing characteristic that relates to the user activity. The predicted purchasing characteristic may include a net cost characteristic, an availability characteristic that is based on purchasing urgency, and a convenience characteristic that is based on a return policy of the merchant. For example, the recommendations may indicate that prices will potentially be lower by X % in next Y days; net cost is the lowest at store A in comparison to other stores; net cost is the lowest at store A based on current promotions; net cost is the lowest at store A based on price matching; net cost is the lowest online versus in-store; net cost is the lowest at store A based on user store rewards; net cost is the lowest online with user memberships; net cost is the lowest at store A when credit rewards are used; net cost is the lowest when Z credit card is used with cash back; net cost is the lowest when Z credit card is used with rewards; and net cost is the lowest when cash/debit/credit is used.

In another exemplary embodiment, the model may include at least one from among a machine learning model, a statistical model, a mathematical model, a process model, and a data model. The model may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, etc. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

At step S410, the recommendations may be provided to the user. The recommendations may be provided via the API in response to the indication. Consistent with present disclosures, utilization of the API to provide a response to the indication may afford flexibility in implementing the claimed invention. By using the API, the claimed invention may be embedded into an existing platform thereby making it easier to integrate the claimed invention within a current product ecosystem. The API may facilitate the integration of the claimed invention within existing applications, websites, and/or portals. In another exemplary embodiment, the claimed invention may be delivered as a standalone application to ensure integration into a specific experience journey that is separate from retailers and/or financial portfolios.

In another exemplary embodiment, the claimed invention may generate enriched data assets by capturing user transaction journey data such as, for example, customer preference data, purchasing value chain data, and payment flow data. As will be appreciated by a person of ordinary skill in the art, the user transaction journey data may be leveraged by financial institutions and retailers to enhance product and service offerings by creating opportunities for cross selling, customer retention, and brand loyalty while also providing better value propositions relating to money and financial productivity for customers.

In another exemplary embodiment, the enriched data assets may be generated by retrieving preferences that correspond to the user via a graphical user interface. Consistent with present disclosures, the user preferences may be retrieved based on a user interaction with the graphical user interface to manually input preference information as well as retrieved automatically based on recognition of user patterns in historical transaction data. The reference data may also be parsed to identify user data that correspond to the user. Then, the profile that corresponds to the user may be enriched with the preference and the identified user data.

In another exemplary embodiment, a transaction journey data set may be generated based on the enriched data assets. The transaction journey data set may be generated for user based on the enriched profile by using the model. The transaction journey data set may relate to a pattern of consumption such as, for example, consumption of products and/or services for the user. Then, the transaction journey data set may be associated with the corresponding user and persisted in a memory device.

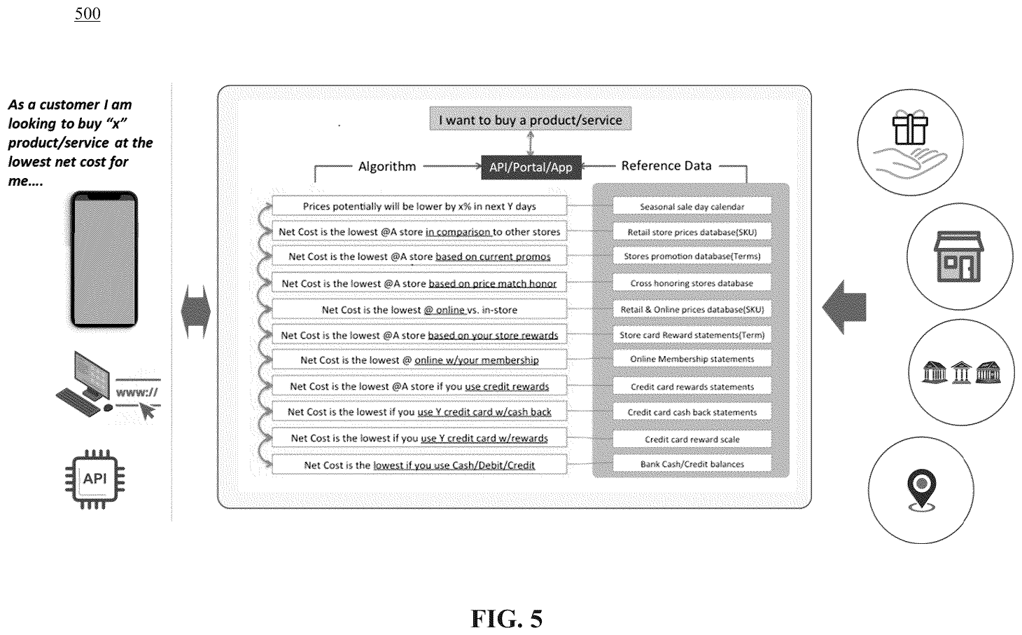

FIG. 5 is a flow diagram 500 of an exemplary process for implementing a method for providing personalized recommendations in real-time via predictive analytics and data aggregation to facilitate electronic transactions. In FIG. 5, a technology platform such as, for example, PRPA device 202 is provided with built-in algorithms and decision models that enable a personalized smart purchasing experience for customers based on market offers, availabilities, geographical locations, customer financial profiles, third-party benefits, channel options, seasonality, and other similar variables against customer priority preferences. The personalized smart purchasing experience may be provided in one place for various modes of engagement such as, for example, mobile computing devices and personal computing devices.

As illustrated in FIG. 5, a customer may engage with the technology platform consistent with present disclosures to indicate a desire to purchase a product and/or service. The indication is then received by the technology platform. Consistent with present disclosures, the technology platform may utilize aggregated reference data and decision models to provide recommendations for the customer. The reference data may be aggregated from a variety of first-party and third-party sources, and the recommendations may be provided to the customer for various modes of engagement.

Accordingly, with this technology, an optimized process for providing personalized recommendations in real-time via predictive analytics and data aggregation to facilitate electronic transactions is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing personalized recommendations in real-time to facilitate electronic transactions, the method being implemented by at least one processor, the method comprising:
automatically aggregating, by the at least one processor, reference data from at least one source, the reference data including user data and merchant data;
receiving, by the at least one processor via an application programming interface, an indication from at least one user, the indication including data that relates to a corresponding user activity;
identifying, by the at least one processor, at least one profile that corresponds to the at least one user;
determining, by the at least one processor in real-time using at least one model, at least one recommendation for the at least one user based on the indication, the reference data, and the at least one profile; and
providing, by the at least one processor via the application programming interface, the at least one recommendation to the at least one user in response to the indication.

2. The method of claim 1, wherein the user data includes information that corresponds to the at least one user, the information relating to at least one from among banking account information, payment card information, membership information, and rewards information.

3. The method of claim 1, wherein the merchant data includes information that corresponds to at least one merchant, the information relating to at least one from among promotion information, calendar information, pricing information, availability information, geographic location information, product information, and service information.

4. The method of claim 1, wherein the user activity relates to an interaction between the at least one user and at least one electronic transaction platform via a graphical user interface, the interaction including a purchasing interaction.

5. The method of claim 4, wherein the purchasing interaction relates to a procurement of at least one from among a consumer product, a real property, an automobile, a financial instrument, and an insurance product.

6. The method of claim 1, further comprising:
retrieving, by the at least one processor via a graphical user interface, at least one preference that corresponds to the at least one user;
parsing, by the at least one processor, the reference data to identify the user data that correspond to the at least one user; and
enriching, by the at least one processor, the at least one profile that corresponds to the at least one user with the at least one preference and the identified user data.

7. The method of claim 6, further comprising:
generating, by the at least one processor using the at least one model, a transaction journey data set for each of the at least one user based on the enriched at least one profile, the transaction journey data set relating to a pattern of consumption; and
associating, by the at least one processor, the transaction journey data set with the corresponding at least one user.

8. The method of claim 1, wherein the at least one recommendation includes an action, a predicted outcome based on the action, and a predicted purchasing characteristic that relates to the user activity, the predicted purchasing characteristic including a net cost characteristic.

9. The method of claim 1, wherein the at least one model includes at least one from among a machine learning model, a mathematical model, a process model, and a data model.

10. A computing device configured to implement an execution of a method for providing personalized recommendations in real-time to facilitate electronic transactions, the computing device comprising:
a processor;
a memory; and
a communication interface coupled to each of the processor and the memory,
wherein the processor is configured to:
automatically aggregate reference data from at least one source, the reference data including user data and merchant data;
receive, via an application programming interface, an indication from at least one user, the indication including data that relates to a corresponding user activity;
identify at least one profile that corresponds to the at least one user;
determine, in real-time by using at least one model, at least one recommendation for the at least one user based on the indication, the reference data, and the at least one profile; and
provide, via the application programming interface, the at least one recommendation to the at least one user in response to the indication.

11. The computing device of claim 10, wherein the user data includes information that corresponds to the at least one user, the information relating to at least one from among banking account information, payment card information, membership information, and rewards information.

12. The computing device of claim 10, wherein the merchant data includes information that corresponds to at least one merchant, the information relating to at least one from among promotion information, calendar information, pricing information, availability information, geographic location information, product information, and service information.

13. The computing device of claim 10, wherein the user activity relates to an interaction between the at least one user and at least one electronic transaction platform via a graphical user interface, the interaction including a purchasing interaction.

14. The computing device of claim 13, wherein the purchasing interaction relates to a procurement of at least one from among a consumer product, a real property, an automobile, a financial instrument, and an insurance product.

15. The computing device of claim 10, wherein the processor is further configured to:
retrieve, via a graphical user interface, at least one preference that corresponds to the at least one user;
parse the reference data to identify the user data that correspond to the at least one user; and
enrich the at least one profile that corresponds to the at least one user with the at least one preference and the identified user data.

16. The computing device of claim 15, wherein the processor is further configured to:
generate, by using the at least one model, a transaction journey data set for each of the at least one user based on the enriched at least one profile, the transaction journey data set relating to a pattern of consumption; and
associate the transaction journey data set with the corresponding at least one user.

17. The computing device of claim 10, wherein the at least one recommendation includes an action, a predicted outcome based on the action, and a predicted purchasing characteristic that relates to the user activity, the predicted purchasing characteristic including a net cost characteristic.

18. The computing device of claim 10, wherein the at least one model includes at least one from among a machine learning model, a mathematical model, a process model, and a data model.

19. A non-transitory computer readable storage medium storing instructions for providing personalized recommendations in real-time to facilitate electronic transactions, the storage medium comprising executable code which, when executed by a processor, causes the processor to:
automatically aggregate reference data from at least one source, the reference data including user data and merchant data;
receive, via an application programming interface, an indication from at least one user, the indication including data that relates to a corresponding user activity;
identify at least one profile that corresponds to the at least one user;
determine, in real-time by using at least one model, at least one recommendation for the at least one user based on the indication, the reference data, and the at least one profile; and
provide, via the application programming interface, the at least one recommendation to the at least one user in response to the indication.

20. The storage medium of claim 19, wherein the at least one recommendation includes an action, a predicted outcome based on the action, and a predicted purchasing characteristic that relates to the user activity, the predicted purchasing characteristic including a net cost characteristic.
